(19) United States
(12) Patent Application Publication
(10) Pub. No.: US 2024/0338725 A1
(43) Pub. Date: Oct. 10, 2024

(54) LAUNDRY APPLIANCES USER SCORING

(71) Applicant: Haier US Appliance Solutions, Inc., Wilmington, DE (US)

(72) Inventors: Joshua Reeves, Louisville, KY (US); Ryan James Scheckelhoff, Louisville, KY (US)

(21) Appl. No.: 18/296,754

(22) Filed: Apr. 6, 2023

(51) Int. Cl. G06Q 30/0207; G06Q 30/0645

(52) U.S. Cl. CPC G06Q 30/0224; G06Q 30/0645

(57) ABSTRACT

A method of operating a laundry appliance includes identifying a user of the laundry appliance. The method also includes detecting an interaction of the user with the laundry appliance and determining a point value for the detected interaction. The method further includes adjusting a user score in a user profile associated with the user based on the determined point value for the detected interaction.

### FIELD OF THE INVENTION

The present subject matter relates generally to laundry appliances with features for managing one or more laundry appliances and user interactions therewith.

### BACKGROUND OF THE INVENTION

Laundry appliances generally include washing machine appliances and dryer appliances. Such laundry appliances may be deployed in a commercial setting, such as in a laundromat, dormitory, or apartment building. Such commercial settings are referred to herein collectively as “laundromat” purely for the sake of brevity and without limiting the commercial laundry appliances to any particular setting.

Such commercial laundry appliances may be rented by a user. Over time, a plurality of users may rent out each such laundry appliance, and such users may have varied expectations and demands for the laundry appliance. Certain users' operation of the laundry appliance may be overall benign or beneficial for the appliance itself and/or the operation of the laundromat as a whole. Other users, however, may operate the laundry appliance in ways that are detrimental to the maintenance of the laundry appliance and/or to smooth and efficient operation of the laundry appliance or laundromat as a whole.

Thus, systems and methods for monitoring user interactions with one or more commercial laundry appliances may be useful. In particular, systems and methods which provide incentives to encourage desired user behavior, e.g., interactions with the commercial laundry appliance(s), and to discourage undesired user interactions with such laundry appliances may be useful in the art.

### BRIEF DESCRIPTION OF THE INVENTION

Aspects and advantages of the invention will be set forth in part in the following description, or may be obvious from the description, or may be learned through practice of the invention.

In accordance with one embodiment of the present disclosure, a method of operating a group of laundry appliances is provided. The group of laundry appliances are connected to a remote computing environment. The method includes identifying a user at one laundry appliance of the group of laundry appliances. The method also includes detecting an interaction of the identified user with the one laundry appliance and determining a point value for the detected interaction. The method further includes adjusting a user score associated with the identified user based on the determined point value for the detected interaction. The user score is in a user profile stored in the remote computing environment.

In accordance with another embodiment of the present disclosure, a method of operating a group of laundry appliances is provided. The method includes identifying a user of the laundry appliance. The method also includes detecting an interaction of the user with the laundry appliance and determining a point value for the detected interaction. The method further includes adjusting a user score in a user profile associated with the user based on the determined point value for the detected interaction.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 provides a front view of an exemplary washing machine appliance and an exemplary dryer appliance in accordance with one or more exemplary embodiments of the present disclosure.

FIG. 2 provides a transverse cross-sectional view of the exemplary washing machine appliance of FIG. 1.

FIG. 3 provides a perspective view of the exemplary dryer appliance of FIG. 1 with portions of a cabinet of the dryer appliance removed to reveal certain components of the dryer appliance.

FIG. 4 provides a schematic diagram of a laundry appliance in communication with a remote user interface device and a remote database according to one or more embodiments of the present disclosure.

FIG. 5 provides a flowchart illustrating an example method of operating a group of laundry appliances according to one or more embodiments of the present disclosure.

FIG. 6 provides a flowchart illustrating another example method of operating a group of laundry appliances according to one or more additional embodiments of the present disclosure.

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

As used herein, terms of approximation, such as “generally,” or “about” include values within ten percent greater or less than the stated value. When used in the context of an angle or direction, such terms include within ten degrees greater or less than the stated angle or direction. For example, “generally vertical” includes directions within ten degrees of vertical in any direction, e.g., clockwise or counterclockwise.

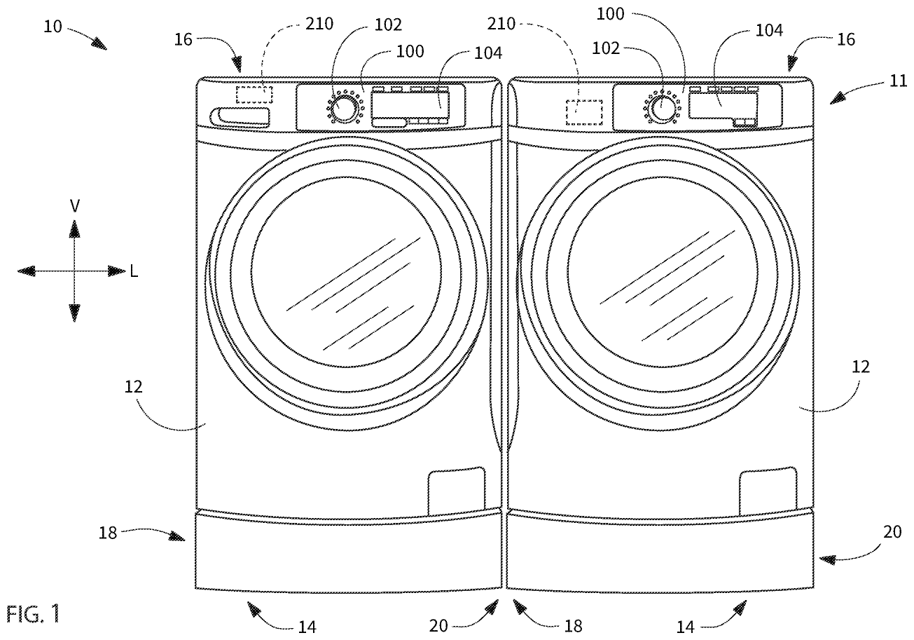

As may be seen in FIGS. 1 through 3, in accordance with one or more embodiments of the present subject matter, a group of at least two laundry appliances, e.g., a pair of laundry appliances is provided. For example, such group of laundry appliances may be commercial laundry appliances, e.g., which a user can reserve or rent for a period of time or a single operation or cycle in exchange for payment. Thus, the commercial laundry appliance may be configured for receiving or verifying payment and unlocking on a limited basis in response to such payment, e.g., for a specific period of time, specific operation or cycle, and/or for a specific user such as a user who has reserved the laundry appliance.

As may be seen generally throughout FIGS. 1 through 3, a user interface panel 100 and a user input device 102 may be positioned on an exterior of each laundry appliance. The user input device 102 is generally positioned proximate to the user interface panel 100, and in some embodiments, the user input device 102 may be positioned on the user interface panel 100.

In various embodiments, the user interface panel 100 may represent a general purpose I/O (“GPIO”) device or functional block. In some embodiments, the user interface panel 100 may include or be in operative communication with user input device 102, such as one or more of a variety of digital, analog, electrical, mechanical or electro-mechanical input devices including rotary dials, control knobs, push buttons, and touch pads. The user interface panel 100 may include a display component 104, such as a digital or analog display device designed to provide operational feedback to a user. The display component 104 may also be a touchscreen capable of receiving a user input, such that the display component 104 may also be a user input device in addition to or instead of the user input device 102.

Generally, each appliance may include a controller 210 in operative communication with the user input device 102. The user interface panel 100 and the user input device 102 may be in communication with the controller 210 via, for example, one or more signal lines or shared communication busses. Input/output (“I/O”) signals may be routed between controller 210 and various operational components of the appliance. Operation of the appliance can be regulated by the controller 210 that is operatively coupled to the user interface panel 100. A user interface panel 100 may for example provide selections for user manipulation of the operation of an appliance, e.g., via user input device 102 and/or display 104. In response to user manipulation of the user interface panel 100 and/or user input device 102, the controller 210 may operate various components of the appliance. Controller 210 may include a memory and one or more microprocessors, CPUs or the like, such as general or special purpose microprocessors operable to execute programming instructions or micro-control code associated with operation of the appliance. The memory may represent random access memory such as DRAM, or read only memory such as ROM or FLASH. In one embodiment, the processor executes programming instructions stored in memory. The memory may be a separate component from the processor or may be included onboard within the processor. Alternatively, a controller 210 may be constructed without using a microprocessor, e.g., using a combination of discrete analog and/or digital logic circuitry (such as switches, amplifiers, integrators, comparators, flip-flops, AND gates, and the like) to perform control functionality instead of relying upon software.

The controller 210 may be programmed to operate the appliance by executing instructions stored in memory. For example, the instructions may be software or any set of instructions that when executed by the processing device, cause the processing device to perform operations. Controller 210 can include one or more processor(s) and associated memory device(s) configured to perform a variety of computer-implemented functions and/or instructions (e.g. performing the methods, steps, calculations and the like and storing relevant data as disclosed herein). It should be noted that controllers 210 as disclosed herein are capable of and may be operable to perform any methods and associated method steps as disclosed herein.

In some embodiments, for example, as illustrated in FIG. 1, the group, e.g., pair, of laundry appliances may include a washing machine appliance 10 and a dryer appliance 11. In embodiments such as illustrated in FIG. 1, the user input device 102 of each appliance 10 and 11 may be positioned on the user interface panel 100. The embodiment illustrated in FIG. 1 also includes a display 104 on the user interface panel 100 of each household appliance 10 and 11.

As generally seen throughout FIGS. 1 through 3, in at least some embodiments, each laundry appliance 10 and 11 includes a cabinet 12 which defines a vertical direction V and a lateral direction L that are mutually perpendicular. Each cabinet 12 extends between a top side 16 and a bottom side 14 along the vertical direction V. Each cabinet 12 also extends between a left side 18 and a right side 20, e.g., along the lateral direction L.

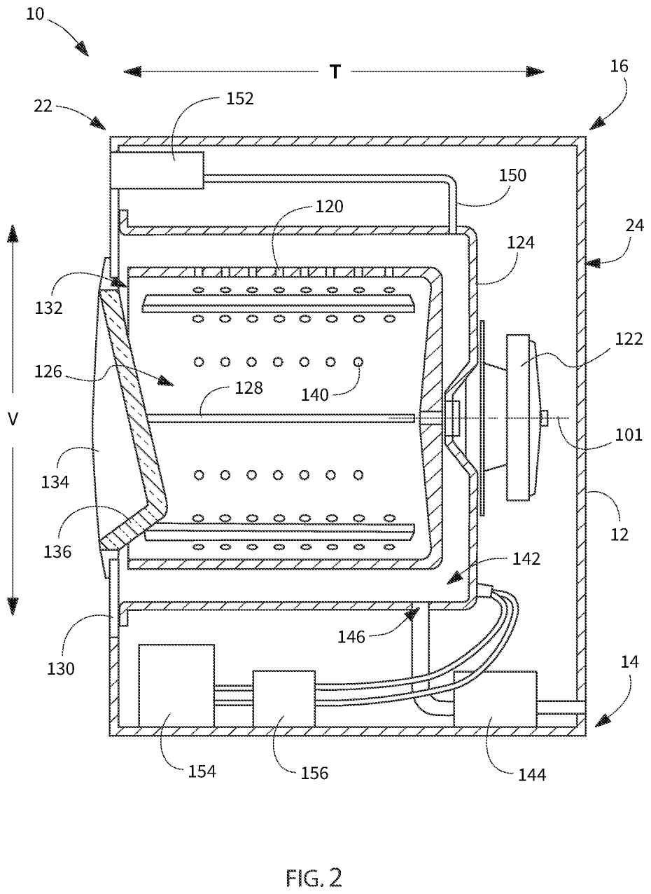

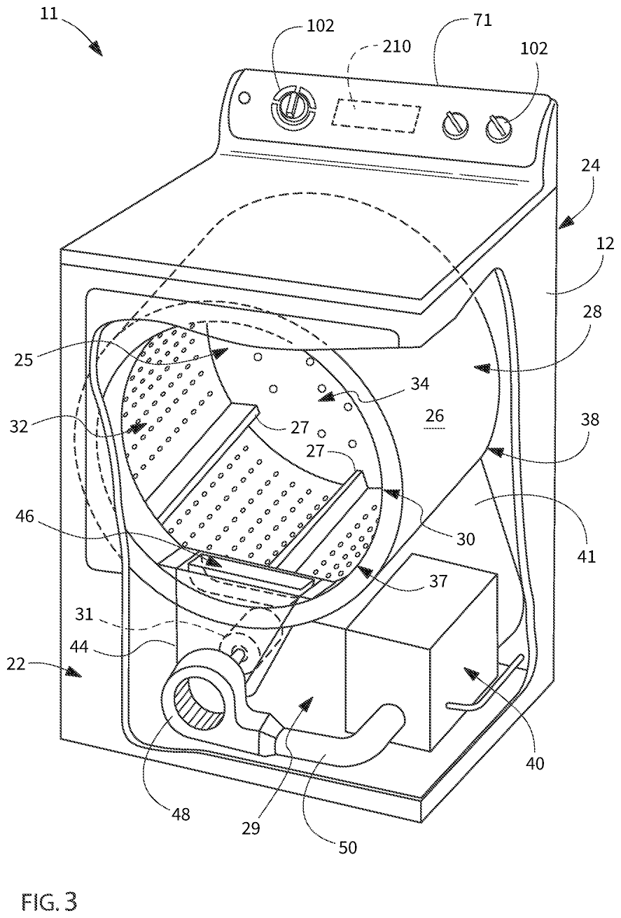

Additional exemplary details of the laundry appliances are illustrated in FIGS. 2 and 3. For example, FIG. 2 provides a cross-sectional view of the exemplary washing machine appliance 10. As illustrated in FIG. 2, a wash tub 124 is non-rotatably mounted within cabinet 12. As may be seen in FIG. 2, the wash tub 124 defines a central axis 101. In the example embodiment illustrated by FIG. 2, the central axis 101 may be oriented generally along or parallel to the transverse direction T of the washing machine appliance 10. Accordingly, the washing machine appliance 10 may be referred to as a horizontal axis washing machine.

Referring again to FIG. 2, a wash basket 120 is rotatably mounted within the tub 124 such that the wash basket 120 is rotatable about an axis of rotation, which generally coincides with central axis 101 of the tub 124. A motor 122, e.g., such as a pancake motor, is in mechanical communication with wash basket 120 to selectively rotate wash basket 120 (e.g., during an agitation or a rinse cycle of washing machine appliance 10). Wash basket 120 defines a wash chamber 126 that is configured for receipt of articles for washing. The wash tub 124 holds wash and rinse fluids for agitation in wash basket 120 within wash tub 124. As used herein, “wash fluid” may refer to water, detergent, fabric softener, bleach, or any other suitable wash additive or combination thereof. The wash basket 120 and the tub 124 may collectively define at least a portion of a tub assembly for the washing machine appliance 10.

Wash basket 120 may define one or more agitator features that extend into wash chamber 126 to assist in agitation and cleaning of articles disposed within wash chamber 126 during operation of washing machine appliance 10. For example, as illustrated in FIG. 2, a plurality of ribs 128 extends from basket 120 into wash chamber 126. In this manner, for example, ribs 128 may lift articles disposed in wash basket 120 during rotation of wash basket 120.

Referring generally to FIGS. 1 and 2, cabinet 12 also includes a front panel 130 which defines an opening 132 that permits user access to wash basket 120 within wash tub 124. More specifically, washing machine appliance 10 includes a door 134 that is positioned in front of opening 132 and is rotatably mounted to front panel 130. Door 134 is rotatable such that door 134 permits selective access to opening 132 by rotating between an open position (not shown) facilitating access to a wash tub 124 and a closed position (FIG. 1) prohibiting access to wash tub 124.

A window 136 in door 134 permits viewing of wash basket 120 when door 134 is in the closed position, e.g., during operation of washing machine appliance 10. Door 134 also includes a handle (not shown) that, e.g., a user may pull when opening and closing door 134. Further, although door 134 is illustrated as mounted to front panel 130, it should be appreciated that door 134 may be mounted to another side of cabinet 12 or any other suitable support according to alternative embodiments.

Referring again to FIG. 2, wash basket 120 also defines a plurality of perforations 140 in order to facilitate fluid communication between an interior of basket 120 and wash tub 124. A sump 142 is defined by wash tub 124 at a bottom of wash tub 124 along the vertical direction V. Thus, sump 142 is configured for receipt of and generally collects wash fluid during operation of washing machine appliance 10. For example, during operation of washing machine appliance 10, wash fluid may be urged by gravity from basket 120 to sump 142 through plurality of perforations 140. A pump assembly 144 is located beneath tub 124 for gravity assisted flow when draining tub 124, e.g., via a drain 146. Pump assembly 144 may be configured for recirculating wash fluid within wash tub 124.

A spout 150 is configured for directing a flow of fluid into wash tub 124. For example, spout 150 may be in fluid communication with a water supply (not shown) in order to direct fluid (e.g., clean water) into wash tub 124. Spout 150 may also be in fluid communication with the sump 142. For example, pump assembly 144 may direct wash fluid disposed in sump 142 to spout 150 in order to circulate wash fluid in wash tub 124.

As illustrated in FIG. 2, a detergent drawer 152 is slidably mounted within front panel 130. Detergent drawer 152 receives a wash additive (e.g., detergent, fabric softener, bleach, or any other suitable liquid or powder) and directs the fluid additive to wash chamber 124 during operation of washing machine appliance 10. According to the illustrated embodiment, detergent drawer 152 may also be fluidly coupled to spout 150 to facilitate the complete and accurate dispensing of wash additive.

Additionally, a bulk reservoir 154 is disposed within cabinet 12. Bulk reservoir 154 is also configured for receipt of fluid additive for use during operation of washing machine appliance 10. Bulk reservoir 154 is sized such that a volume of fluid additive sufficient for a plurality or multitude of wash cycles of washing machine appliance 10 (e.g., five, ten, twenty, fifty, or any other suitable number of wash cycles) may fill bulk reservoir 154. Thus, for example, a user can fill bulk reservoir 154 with fluid additive and operate washing machine appliance 10 for a plurality of wash cycles without refilling bulk reservoir 154 with fluid additive. A reservoir pump 156 is configured for selective delivery of the fluid additive from bulk reservoir 154 to wash tub 124.

During operation of washing machine appliance 10, e.g., during a wash cycle of the washing machine appliance 10, a laundry items are loaded into wash basket 120 through opening 132, and washing operation is initiated through operator manipulation of input selectors 102. Wash tub 124 is filled with water, detergent, and/or other fluid additives, e.g., via spout 150 and/or detergent drawer 152. One or more valves (not shown) can be controlled by washing machine appliance 10 to provide for filling wash basket 120 to the appropriate level for the amount of articles being washed and/or rinsed. By way of example for a wash mode, once wash basket 120 is properly filled with fluid, the contents of wash basket 120 can be agitated (e.g., with ribs 128) for washing of laundry items in wash basket 120.

After the agitation phase of the wash cycle is completed, wash tub 124 can be drained. Laundry articles can then be rinsed by again adding fluid to wash tub 124, depending on the particulars of the cleaning cycle selected by a user. Ribs 128 may again provide agitation within wash basket 120. One or more spin cycles may also be used. In particular, a spin cycle may be applied after the wash cycle and/or after the rinse cycle in order to wring wash fluid from the articles being washed. During a spin cycle, basket 120 is rotated at relatively high speeds. After articles disposed in wash basket 120 are cleaned and/or washed, the user can remove the articles from wash basket 120, e.g., by opening door 134 and reaching into wash basket 120 through opening 132.

While described in the context of a specific embodiment of horizontal axis washing machine appliance 10, using the teachings disclosed herein it will be understood that horizontal axis washing machine appliance 10 is provided by way of example only. It should be appreciated that the present subject matter is not limited to any particular style, model, or configuration of washing machine appliance. Other washing machine appliances having different configurations, different appearances, and/or different features may also be utilized with the present subject matter as well, e.g., vertical axis washing machine appliances.

FIG. 3 provides a perspective view of the dryer appliance 11 of FIG. 1, which is an example embodiment of a household appliance, with a portion of a cabinet or housing 12 of dryer appliance 11 removed in order to show certain components of dryer appliance 11. Dryer appliance 11 generally defines a vertical direction V, a lateral direction L, and a transverse direction T, each of which is mutually perpendicular, such that an orthogonal coordinate system is defined. While described in the context of a specific embodiment of dryer appliance 11, using the teachings disclosed herein, it will be understood that dryer appliance 11 is provided by way of example only. Other dryer appliances having different appearances and different features may also be utilized with the present subject matter as well.

Cabinet 12 includes a front side 22 and a rear side 24 spaced apart from each other along the transverse direction T. Within cabinet 12, an interior volume 29 is defined. A drum or container 26 is mounted for rotation about a substantially horizontal axis within the interior volume 29. Drum 26 defines a chamber 25 for receipt of articles of clothing for tumbling and/or drying. Drum 26 extends between a front portion 37 and a back portion 38. Drum 26 also includes a back or rear wall 34, e.g., at back portion 38 of drum 26. A supply duct 41 may be mounted to rear wall 34 and receives heated air that has been heated by a heating assembly or system 40.

As used herein, the terms “clothing” or “articles” include but need not be limited to fabrics, textiles, garments, linens, papers, or other items from which the extraction of moisture is desirable. Furthermore, the term “load” or “laundry load” refers to the combination of clothing that may be washed together in a washing machine or dried together in a dryer appliance 11 (e.g., clothes dryer) and may include a mixture of different or similar articles of clothing of different or similar types and kinds of fabrics, textiles, garments and linens within a particular laundering process.

A motor 31 is provided in some embodiments to rotate drum 26 about the horizontal axis, e.g., via a pulley and a belt (not pictured). Drum 26 is generally cylindrical in shape, having an outer cylindrical wall 28 and a front flange or wall 30 that defines an opening 32 of drum 26, e.g., at front portion 37 of drum 26, for loading and unloading of articles into and out of chamber 25 of drum 26. A plurality of lifters or baffles 27 are provided within chamber 25 of drum 26 to lift articles therein and then allow such articles to tumble back to a bottom of drum 26 as drum 26 rotates. Baffles 27 may be mounted to drum 26 such that baffles 27 rotate with drum 26 during operation of dryer appliance 11.

The rear wall 34 of drum 26 may be rotatably supported within the cabinet 12 by a suitable fixed bearing. Rear wall 34 can be fixed or can be rotatable. Rear wall 34 may include, for instance, a plurality of holes that receive hot air that has been heated by heating system 40. The heating system 40 may include, e.g., a heat pump, an electric heating element, and/or a gas heating element (e.g., gas burner). Moisture laden, heated air is drawn from drum 26 by an air handler, such as blower fan 48, which generates a negative air pressure within drum 26. The moisture laden heated air passes through a duct 44 enclosing screen filter 46, which traps lint particles. As the air passes from blower fan 48, it enters a duct 50 and then is passed into heating system 40. In some embodiments, the dryer appliance 11 may be a conventional dryer appliance, e.g., the heating system 40 may be or include an electric heating element, e.g., a resistive heating element, or a gas-powered heating element, e.g., a gas burner. In other embodiments, the dryer appliance may be a condensation dryer, such as a heat pump dryer. In such embodiments, heating system 40 may be or include a heat pump including a sealed refrigerant circuit. Heated air (with a lower moisture content than was received from drum 26), exits heating system 40 and returns to drum 26 by duct 41. After the clothing articles have been dried, they are removed from the drum 26 via opening 32. A door (FIG. 1) provides for closing or accessing drum 26 through opening 32.

In some embodiments, one or more selector inputs 102, such as knobs, buttons, touchscreen interfaces, etc., may be provided or mounted on the cabinet 12 (e.g., on a backsplash 71) and are in operable communication (e.g., electrically coupled or coupled through a wireless network band) with the processing device or controller 210. Controller 210 may also be provided in operable communication with components of the dryer appliance 11 including motor 31, blower 48, or heating system 40. In turn, signals generated in controller 210 direct operation of motor 31, blower 48, or heating system 40 in response to the position of inputs 102. As used herein, “processing device” or “controller” may refer to one or more microprocessors, microcontroller, application-specific integrated circuits (ASICS), or semiconductor devices and is not restricted necessarily to a single element. The controller 210 may be programmed to operate dryer appliance 11 by executing instructions stored in memory (e.g., non-transitory media). The controller 56 may include, or be associated with, one or more memory elements such as random access memory (RAM), read-only memory (ROM), or electrically erasable, programmable read only memory (EEPROM). For example, the instructions may be software or any set of instructions that when executed by the processing device, cause the processing device to perform operations. It should be noted that controllers as disclosed herein are capable of and may be operable to perform any methods and associated method steps as disclosed herein. For example, in some embodiments, methods disclosed herein may be embodied in programming instructions stored in the memory and executed by the controller 210.

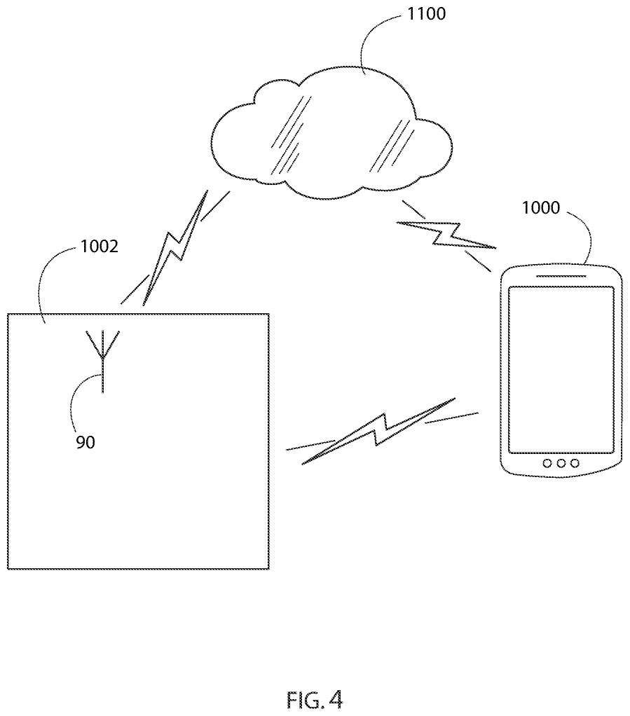

Turning now to FIG. 4, a general schematic of a laundry appliance 1002, which may be, e.g., the washing machine appliance 10 or the dryer appliance 11 described above (or both,) and communication features thereof is provided. FIG. 4 schematically illustrates a laundry appliance 1002, which may be, for example, one of the laundry appliances 10 or 11 of FIGS. 1 through 3, among other possible example laundry appliances, which communicates wirelessly with a remote user interface device 1000. For example, as illustrated in FIG. 4, the laundry appliance 1002 may include an antenna 90 by which the laundry appliance 1002 communicates with, e.g., sends and receives signals to and from, the remote user interface device 1000. The laundry appliance 1002 may communicate with the remote user interface device 1000 over a direct wireless communication link or over an indirect wireless communication link, such as via a remote server, a network, or cloud 1100. The remote user interface device 1000 may be a laptop computer, smartphone, tablet, personal computer, wearable device, smart home system, and/or various other suitable devices.

The laundry appliance 1002 may be in communication with the remote user interface device 1000 device through various possible communication connections and interfaces. The laundry appliance 1002 and the remote user interface device 1000 may be matched in wireless communication, e.g., connected to the same wireless network. The laundry appliance 1002 may communicate with the remote user interface device 1000 via short-range radio such as BLUETOOTH® or any other suitable wireless network having a layer protocol architecture. As used herein, “short-range” may include ranges less than about ten meters and up to about one hundred meters. For example, the wireless network may be adapted for short-wavelength ultra-high frequency (UHF) communications in a band between 2.4 GHz and 2.485 GHz (e.g., according to the Institute of Electrical and Electronics Engineers (IEEE) 802.15.1 standard). In particular, BLUETOOTH® Low Energy, e.g., BLUETOOTH® Version 4.0 or higher, may advantageously provide short-range wireless communication between the appliance 10 and the remote user interface device 1000. For example, BLUETOOTH® Low Energy may advantageously minimize the power consumed by the exemplary methods and devices described herein due to the low power networking protocol of BLUETOOTH® Low Energy.

The remote user interface device 1000 is “remote” at least in that it is spaced apart from and not physically connected to the laundry appliance 1002, e.g., the remote user interface device 1000 is a separate, stand-alone device from the laundry appliance 1002 which communicates with the laundry appliance 1002 wirelessly. Any suitable device separate from the laundry appliance 1002 that is configured to provide and/or receive communications, information, data, or commands from a user may serve as the remote user interface device 1000, such as a smartphone (e.g., as illustrated in FIG. 4), smart watch, personal computer, smart home system, or other similar device. For example, the remote user interface device 1000 may be a smartphone operable to store and run applications, also known as “apps,” and some or all of the method steps disclosed herein may be performed by a smartphone app.

The remote user interface device 1000 may include a memory for storing and retrieving programming instructions. Thus, the remote user interface device 1000 may provide a remote user interface which may be an additional user interface to the user interface panel 100. For example, the remote user interface device 1000 may be a smartphone operable to store and run applications, also known as “apps,” and the remote user interface may be provided as a smartphone app.

As mentioned above, the laundry appliance 1002 may also be configured to communicate wirelessly with a remote database 1100. The remote database 1100 may be, e.g., a cloud-based data storage system. For example, the laundry appliance 1002 may communicate with the remote database 1100 over the Internet, which the laundry appliance 1002 may access via WI-FI®, such as from a WI-FI® access point in a user's home or in a commercial setting such as a laundromat, apartment, or dormitory, etc.

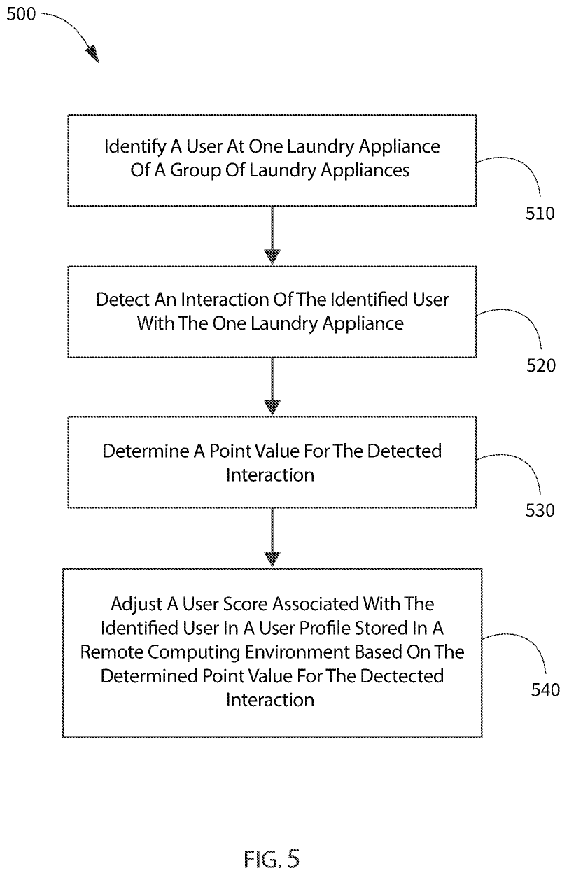

As illustrated in FIG. 5, embodiments of the present disclosure also include methods of operating a group of laundry appliances, e.g., laundry appliances 10 and 11 described above, among other possible exemplary laundry appliances. For example, the group of laundry appliances may be connected to a remote computing environment, such as the group of laundry appliances may be connected to the cloud for remote management and/or operation of one or more of the laundry appliance by an owner or user of one or more of the laundry appliances. For example, a laundry appliance may be reserved in the cloud or user preferences may be obtained from the cloud for operation of a laundry appliance. As another example, the group of laundry appliances may be remotely maintained by an owner of the of group of laundry appliances, such as a laundromat owner. Such remote maintenance may include setting pricing, parameter limits, or other rules for the laundry appliances and operation thereof, e.g., such as defining certain user interactions or point values therefor, as described in further detail below. Exemplary methods according to the present subject matter include the method 500 illustrated in FIG. 5. Such methods may be wholly or partially computer-implemented, such as implemented by a controller, e.g., controller 210, of one or more laundry appliances and/or implemented by one or more remote computing devices, e.g., in the cloud, fog, or edge, or other distributed computing environment.

As illustrated in FIG. 5, the method 500 may include a step 510 of identifying a user at one laundry appliance of the group of laundry appliances. For example, such identification of the user may include determining which user account the laundry appliance was rented by, e.g., in embodiments where the group of laundry appliances are commercial laundry appliances such as in a laundromat, etc. Such rental may be performed remotely, e.g., in a laundry app on a remote user interface device, and steps such as reserving the selected laundry appliance for the user, debiting the user account for the rental amount, etc., may be performed by a remote computing device, e.g., in the cloud as described.

Method 500 may further include a step 520 of detecting an interaction of the identified user with the one laundry appliance. Such interactions may include (without limitation) reporting a valid machine issue, visiting the group of appliances frequently (where the group of laundry appliances may be in the same laundromat or may be owned by the same owner across multiple locations), or using the group of appliances at off-peak hours. As will be discussed in further detail below, interactions such as the foregoing examples may be positive interactions. Additional exemplary interactions which may be detected include negative interactions, such as reporting a false machine issue (e.g., to obtain a refund that is not merited), overloading the laundry appliance, leaving the laundry appliance reserved but not running, attempting to load inappropriate items into the laundry appliance (such as items which have a high probability of creating an out-of-balance condition), not cleaning the lint filter of a dryer appliance after use, performing excessively long cycles (such as long timed dry cycles in embodiments where the laundry appliance is, or the group of laundry appliances includes, a dryer appliance), not removing laundry or other articles from the laundry appliance in a timely manner after completion of the operations, etc. The selection and definitions of such events, e.g., whether to apply a point value to operation time, and, if so, how long is excessively long for a cycle or for articles to remain in a laundry appliance after a cycle, how many repeat trips to the same group of laundry appliances triggers a reward (and what the reward is, or whether to reward loyalty at all) may be established by an owner of the laundry appliance or group of laundry appliance, such as using a computing device running a web-based interface for remote management of one or more laundry appliances.

The interaction may be detected in various ways. For example, the interaction may be detected by the laundry appliance, such as during operation of the laundry appliance. Interactions which may be detected by the laundry appliance may include, for example, overloading the laundry appliance which may be detected by measuring the size, e.g., mass, of the load of articles in the laundry appliance with one or more sensors in the laundry appliance or other components of the laundry appliance, or selected cycle time which may be detected directly by the laundry appliance via the user interface thereof. Numerous other interaction may be detected using sensors or otherwise measuring or monitoring operating conditions (such as motor status, valve status, temperature, or operating time, etc.) in the laundry appliance and by the laundry appliance. The interaction may also be detected after the operation of the laundry appliance as well as or instead of during operation. For example, detecting the interaction may include receiving an input or report from a subsequent user or owner of the laundry appliance, such as where the next user reports an issue with the laundry appliance and the reported issue is a result of the interaction, e.g., is a result of damage to the laundry appliance caused by the interaction.

Method 500 may also include a step 530 of determining a point value for the detected interaction. The point value may, for example, also be established by the owner, such as via a remote management interface for one or more laundry appliances as described above. As mentioned above, the interaction may be a positive interaction or a negative interaction. Thus, the point value may be a positive point value for a positive interaction and a negative point value for a negative interaction, or a point value greater than one for a positive interaction and a point value less than one (e.g., between one and zero, such as 0.75, 0.5, etc.) for a negative interaction. Thus, for example, determining the point value for the detected interaction may include looking up the detected interaction, e.g., in a remote database, and finding an a point value associated therewith in the remote database.

Method 500 may further include a step 540 of adjusting a user score associated with the identified user based on the determined point value for the detected interaction. In some embodiments, the user score may be in a user profile stored in the remote computing environment. For example, adjusting the user score may include adding the point value to the user score, which will result in an increased user score when the point value is a positive number and a decrease in the user score when the point value is a negative number. As another example, adjusting the user score may include multiplying the user score by the point value, which will result in an increased user score when the point value is greater than one and a decrease in the user score when the point value is less than one and greater than zero. It should also be understood that some embodiments may include both of the foregoing examples, e.g., some interactions may result in an adjusting the user score by addition while other interactions with the same laundry appliance (or the same group of laundry appliances) may result in multiplying the user score by the determined point value.

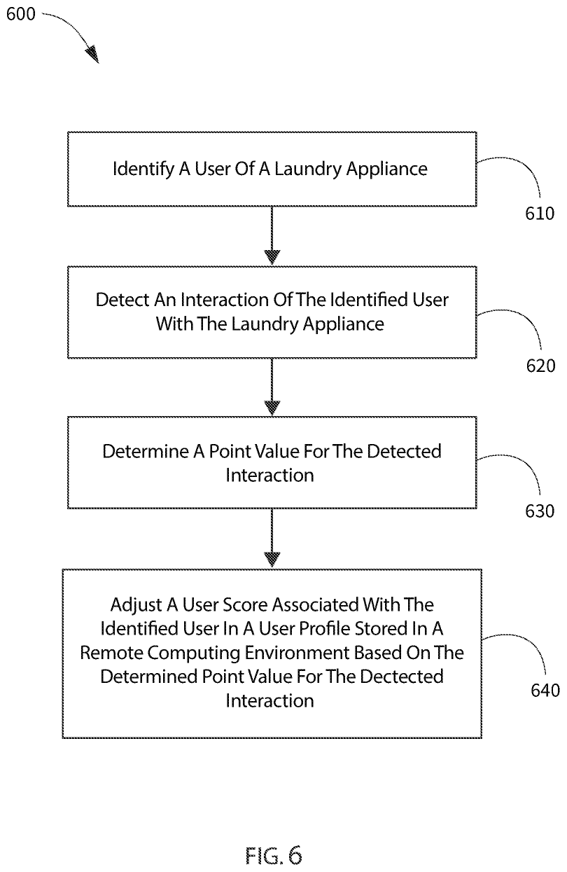

As illustrated in FIG. 6, embodiments of the present disclosure also include methods of operating a laundry appliance, e.g., one of laundry appliances 10 and 11 described above, among other possible exemplary laundry appliances. The laundry appliance of FIG. 6 may be a commercial laundry appliance and may be a single laundry appliance or may be one of a group of laundry appliances. Exemplary methods according to the present subject matter include the method 600 illustrated in FIG. 6. Such methods may be wholly or partially computer-implemented, such as implemented by a controller, e.g., controller 210, of one or more laundry appliances and/or implemented by one or more remote computing devices, e.g., in the cloud, fog, or edge, or other distributed computing environment.

As may be seen in FIG. 6, method 600 may include a step 610 of identifying a user of the laundry appliance, e.g., determining which user account reserved or rented the laundry appliance and identifying the user based on the user's association with such user account, as described above in reference to step 510 of method 500. Method 600 may also include detecting an interaction of the user with the laundry appliance, e.g., as indicated at 620 in FIG. 6. The detected interaction may be a positive interaction or a negative interaction, e.g., as described above. A point value for the detected interaction may be determined, e.g., as indicated at 630 in FIG. 6. In a similar manner as described above with respect to step 530 of method 500, the point value may correspond to whether the detected interaction was a positive or negative interaction, and the point value may be greater than one, less than one but greater than zero, or may be a positive number or a negative number. Method 600 may also include a step 640 of adjusting a user score in a user profile associated with the user based on the determined point value for the detected interaction.

Referring now generally to FIGS. 5 and 6, the methods 500 and/or 600 may be interrelated and/or may have one or more steps from one of the methods 500 and 600 combined with the other method 500 or 600. Thus, those of ordinary skill in the art will recognize that the various steps of the exemplary methods described herein may be combined in various ways to arrive at additional embodiments within the scope of the present disclosure.

In some embodiments, one or more methods according to the present disclosure may be computer-implemented, such as implemented by a controller on board the appliance or implemented at least in part by a remote computing device, e.g., in a distributed computing environment such as the cloud, fog, and/or edge, as mentioned above. Such embodiments may also include one or more steps performed by a remote user interface device which is in communication with the remote computing device, where the remote user interface device and the remote computing device are both remote from the laundry appliances, e.g., as described above with respect to FIG. 4, and are remote from each other. Thus, it should be understood that some or all of the foregoing method steps, e.g., of method 500 and/or method 600, may be performed by the remote user interface device, such as in an app running on, e.g., a smartphone or tablet, by the remote computing device (e.g., in the cloud, edge, or fog), and/or by the laundry appliance(s) or a local on-board controller thereof, in various combinations.

Method 500 or method 600 may also include providing rewards or penalties to a user, such as applying the rewards or penalties to the user account associated with the user, based on the user score. For example, a high user score may be rewarded and a low user score may be penalized. Such rewards may include discounts, such as a reduction in price for a future rental of a laundry appliance from the group of laundry appliances, prioritization when there is a waitlist to rent a laundry appliance, and other similar benefits. Exemplary penalties may include a price increase (or disqualification for a discount), lower prioritization for rental requests or reservations, banishment or suspension from the laundromat or from all laundry appliances within an ecosystem (the ecosystem may be, for example, all laundry appliances—regardless of owner—that are produced by a common manufacturer or are managed in the same cloud system), among other possible penalties for a low user score. For example, one or more user score thresholds may be provided and the reward or penalty may be applied to the user's account whenever the user score moves above or below the threshold or one of the thresholds. As another example, user scores could be compared to the thresholds periodically, such as weekly or monthly, etc., and rewards or penalties may be applied based on the user score at that time (for example, a user score may drop below a threshold intraweek, but the user score may then increase in response to later-detected user interactions before the end of the week or other period and thereby the user account would avoid a penalty or still qualify for a reward). Thus, embodiments of the present disclosure include methods that include, after adjusting the user score, comparing the adjusted user score to a predetermined threshold, and applying a reward to the user profile based on the adjusted user score greater than the predetermined threshold, or that include, after adjusting the user score, comparing the adjusted user score to a predetermined threshold, and applying a penalty to the user profile based on the adjusted user score lower than the predetermined threshold. In various embodiments, the predetermined threshold may be an absolute threshold or a relative threshold. For example, where the user score ranges from zero to ten, the predetermined threshold may be an absolute threshold such as three, where all user scores less than three may receive the penalty, and/or the predetermined threshold may be an absolute threshold such as eight, where all user scores greater than eight may receive the reward. As another example, where the predetermined threshold is a relative threshold, e.g., a percentile, the top X % of user scores may have the reward applied, and/or the bottom Y % of user scores may have the penalty applied.

Embodiments of the present disclosure include methods wherein multiple user interactions are tracked and the user score is updated in response to each interaction. For example, in some embodiments, exemplary methods according to the present disclosure may include detecting a first interaction, and the determined point value may be a first point value for the first interaction. In such embodiments, exemplary methods may further include detecting a second interaction of the identified user with the laundry appliance, determining a second point value for the detected second interaction, and adjusting the user score in the user profile associated with the identified user based on the determined second point value for the detected second interaction. As mentioned, different interactions may have different point values, e.g., the second point value may be not equal to the first point value. Thus, in some embodiments, the first point value may be a first positive value and the second point value may be a second positive value, or the first point value may be a first negative value and the second point value may be a second negative value. As additional examples, the first and second point values may both result in an increased user score, while one may be a number that is added to the user score and the other may be multiplied with the user score, or one of the first and second point values may result in an increased user score while the other results in a decreased user score, or both the first and second point values may be added to or multiplied with the user score to adjust the user score, etc., in various combinations.

Various aspects and embodiments of the present disclosure may provide numerous advantages. For example and without limitation, exemplary methods disclosed herein may provide an improved operation of the laundry appliances, such as longer usable life of the laundry appliances, increased efficiency or safety of the laundry appliances, among other benefits, as a result of tracking user interactions and incenting desired interactions.

In at least some embodiments, the detected user interaction includes activating or operating the laundry appliance, or the detected user interaction with which the point value is specifically associated may be in conjunction with activating or operating the laundry appliance, and the point value for the user interaction may be based on such operation, e.g., whether such operation is beneficial, e.g., efficient or safe or low-maintenance, or not. Further, activating or operating the laundry appliance, e.g., in response to or in conjunction with the user interaction, includes causing at least one mechanical component of the laundry appliance to be operated. For example, the mechanical component may be a motor, such as the motor 122 of the washing machine appliance 10 (FIG. 2) or the motor 31 of the dryer appliance 11 (FIG. 3), a fan, a heating element, a compressor, a pump, or a valve, among other possible example mechanical components of a laundry appliance. Also, operating the mechanical component includes changing a physical status of the component, e.g., a speed, position, etc. of the component, such as accelerating the motor, fan, etc., e.g., from a zero starting speed, opening the valve, and/or other changes in the physical state of one or more mechanical components of the laundry appliance.

Furthermore, the skilled artisan will recognize the interchangeability of various features from different embodiments. Similarly, the various method steps and features described, as well as other known equivalents for each such methods and feature, can be mixed and matched by one of ordinary skill in this art to construct additional systems and techniques in accordance with principles of this disclosure. Of course, it is to be understood that not necessarily all such objects or advantages described above may be achieved in accordance with any particular embodiment. Thus, for example, those skilled in the art will recognize that the systems and techniques described herein may be embodied or carried out in a manner that achieves or optimizes one advantage or group of advantages as taught herein without necessarily achieving other objects or advantages as may be taught or suggested herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

The invention claimed is:

1. A method of operating a group of laundry appliances, the group of laundry appliances connected to a remote computing environment, the method comprising:
identifying a user at one laundry appliance of the group of laundry appliances;
detecting an interaction of the identified user with the one laundry appliance, wherein the detected interaction comprises loading a load of articles into the one laundry appliance;
measuring a size of the load of articles in the one laundry appliance with one or more sensors in the one laundry appliance, wherein the measured size of the load of articles comprises a mass of the load of articles;
determining a point value for the detected interaction based on the measured size of the load of articles; and
adjusting a user score associated with the identified user based on the determined point value for the detected interaction, the user score in a user profile stored in the remote computing environment.

2. The method of claim 1, further comprising determining the measured size of the load of articles is greater than a load size limit, wherein determining the point value for the detected interaction comprises determining a negative point value for the detected interaction based on the measured size greater than the load size limit, and wherein adjusting the user score based on the determined point value for the detected interaction comprises decreasing the user score.

3. The method of claim 1, further comprising determining the measured size of the load of articles is less than or equal to a load size limit, wherein determining the point value for the detected interaction comprises determining a positive point value for the detected interaction based on the measured size less than or equal to the load size limit, and wherein adjusting the user score based on the determined point value for the detected interaction comprises increasing the user score.

4. The method of claim 1, wherein the detected interaction is a first interaction, wherein the determined point value is a first point value for the first interaction, further comprising detecting a second interaction of the identified user with the one laundry appliance, determining a second point value for the detected second interaction, and adjusting the user score in the user profile associated with the identified user based on the determined second point value for the detected second interaction, wherein the second point value is not equal to the first point value.

5. The method of claim 4, wherein the first point value is a first positive value and the second point value is a second positive value.

6. The method of claim 4, wherein the first point value is a first negative value and the second point value is a second negative value.

7. The method of claim 1, wherein adjusting the user score based on the determined point value comprises multiplying the user score by the determined point value.

8. The method of claim 1, further comprising, after adjusting the user score, comparing the adjusted user score to a predetermined threshold, and applying a reward to the user profile based on the adjusted user score greater than the predetermined threshold.

9. The method of claim 1, further comprising, after adjusting the user score, comparing the adjusted user score to a predetermined threshold, and applying a penalty to the user profile based on the adjusted user score lower than the predetermined threshold.

10. A method of operating a laundry appliance, the method comprising:
identifying a user of the laundry appliance;
performing an operation of the laundry appliance in response to a command from the identified user;
detecting an interaction of the user with the laundry appliance after performing the operation, wherein detecting the interaction comprises detecting an opening of a door of the laundry appliance;
determining a point value for the detected interaction based on an elapsed time between performing the operation and detecting the opening of the door; and
adjusting a user score in a user profile associated with the user based on the determined point value for the detected interaction.

11. The method of claim 10, wherein determining the point value for the detected interaction comprises determining a negative point value for the detected interaction based on the elapsed time between performing the operation and detecting the opening of the door greater than a time limit, and wherein adjusting the user score in the user profile associated with the user based on the determined point value for the detected interaction comprises decreasing the user score.

12. The method of claim 10, wherein determining the point value for the detected interaction comprises determining a positive point value for the detected interaction based on the elapsed time between performing the operation and detecting the opening of the door less than or equal to a time limit, and wherein adjusting the user score in the user profile associated with the user based on the determined point value for the detected interaction comprises increasing the user score.

13. The method of claim 10, wherein the detected interaction is a first interaction, wherein the determined point value is a first point value for the first interaction, further comprising detecting a second interaction of the user with the laundry appliance, determining a second point value for the detected second interaction, and adjusting the user score in the user profile associated with the user based on the determined second point value for the detected second interaction, wherein the second point value is not equal to the first point value.

14. The method of claim 13, wherein the first point value is a first positive value and the second point value is a second positive value.

15. The method of claim 13, wherein the first point value is a first negative value and the second point value is a second negative value.

16. The method of claim 10, wherein adjusting the user score based on the determined point value comprises multiplying the user score by the determined point value.

17. The method of claim 10, further comprising, after adjusting the user score, comparing the adjusted user score to a predetermined threshold, and applying a reward to the user profile based on the adjusted user score greater than the predetermined threshold.

18. The method of claim 10, further comprising, after adjusting the user score, comparing the adjusted user score to a predetermined threshold, and applying a penalty to the user profile based on the adjusted user score lower than the predetermined threshold.
